(19) United States
(12) Patent Application Publication
(10) Pub. No.: US 2007/0207441 A1
(43) Pub. Date: Sep. 6, 2007

(54) Four dimensional modeling of jaw and tooth dynamics

(76) Inventor: Mark D. Lauren, Amherst, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/367,632

(22) Filed: Mar. 3, 2006

(51) Int. Cl. A61C 11/00

(52) U.S. Cl. 433/213

(57) ABSTRACT

Methods and systems are described to digitally model the 4-dimensional dynamics of jaw and tooth motion using time-based 3-dimensional data. Complete upper and lower digital models are registered to time-based 3-dimensional intra-oral data to produce a true 4-dimensional model. Diagnostic and clinical applications include balancing the occlusion and characterizing the geometry of the temporomandibular joint. The 4-dimensional model is readily combined with conventional imaging methods such as CT to create a more complete virtual patient model.

### BACKGROUND OF THE INVENTION

This invention relates to the art of modeling jaw and tooth motion, and more particularly to a method and system for providing a high resolution four dimensional model of the true opening and closing paths of a patient's jaws and teeth.

Dental articulators have been used to model jaw motion for over 200 years, with the Gariot model being the first to come into standard use around 1805. Modern articulators are essentially accurately machined versions of the Gariot design, with the addition of adjustable mechanical features that provide additional movements, to more closely model a patient's temporomandibular joint (TMJ). Typical adjustabilities include condylar inclination angle, Bennet angle, and interchangeable plastic inserts for different eminence ramps. Modern fully adjustable articulators are currently used to fabricate state-of-the-art oral appliances and prosthetics.

The mountings used to position the arches on articulators are typically obtained from a face-bow registration and a wax bite. This procedure requires the accurately positioning a framework connected to the patient's mouth and ear canals. A single position in space is defined. Typically, no information exists as to how the patient arrived at this position or how they continue past to full occlusion. A single 3-dimensional snapshot in time is obtained. Subsequent jaw motion is determined by the articulator and not the patient. This limitation of current art has become accepted practice for designing and fabricating oral devices.

Methods are known for capturing and recording 3-dimensional jaw motion. These methods, which require mechanical frames to be attached to the maxilla and mandible, are cumbersome and not very precise. The relative motion between the frames is measured using a variety of sensing methods, including: ultrasonics, magnetic detection, and light triangulation. Rigid pantographs are also used to produce non-electronic data. Attempts to 3-dimensionally model the human jaw based on the analysis of 2-dimensional intraoral images is also known. Theses methods are mechanically complex, and require a fixed extra-oral reference system. Reference may be made to “A System for Human Jaw Modeling Using Intra-Oral Images”, S. Yammany et al., Froc. 20^{th} Conference of IEEE in Medicine and Biology Soc., Vol. 20, No. 2, 1998.

Four-dimensional models consist of three dimensional information that changes with time. There are no methods in the current art for producing a convenient high resolution 4-dimensional model of the true opening and closing paths of an individual patient. While articulators are adequate for fabricating and checking the basic fit of an oral appliance, they are not capable of reproducing a patient's true 3-dimensional jaw motion. True jaw motion is complex, consisting of rotation and translation in more than one plane.

Examples of 4-dimensional modeling in other fields are known. Four-dimensional models have been generated from 3-dimensional fluid flow data, meteorological, ultrasound, and computer tomography (CT) data. Applications include characterizing the location of lung tumors, heart contraction, meteorological studies, and complex flow analyses. Time sequences of meteorological data provide a true 4-dimensional view of evolving atmospheric conditions. Reference may be made to “Four-dimensional Imaging for Meteorological Applications”, Journal of Atmospheric and Oceanic Technology, Vol. 5, No. 1, pp. 136-143. Internal organ motion during respiration can be volumetrically imaged using 4-dimensional computed tomography. Clinical target volumes for radiation treatment can be more accurately defined and followed using 4-dimensional motion methods to improve dose coverage of mobile targets and limit unnecessarily large radiation exposure. Reference may be made to E. Rietzel et al., “Moving targets: Detection and Tracking of Internal Organ Motion for Treatment Planning and Patient Set-Up”, Radiotherapy Oncology December 2004, Suppl. 2:S68-72.

Three-dimensional CT methods can yield accurate 3-dimensional digital models of anatomical structures using scaled voxel elements, allowing accurate 3-dimensional models to be produced in a computer. Each CT scan generally captures a complete 3-dimensional snapshot in space much the same as a bite registration. A series of 3-dimensional x ray scans (as well as a series of bite registrations) can provide 3-dimensional positional data at different jaw positions. In this way, a 4-dimensional model representing mandibular movements was produced using a 3-dimensional CT dataset from a volunteer. Reference may be made to “Four-dimensional Analysis of Mandibular Movements With Optical Position Measuring and Real-Time Imaging, Y. Shijeta et al., Study Health Technology Information 2003, 94:p 315-317. This approach is inconvenient, does not include details of the dentition, and is not practical in terms of radiation exposure.

### SUMMARY OF THE INVENTION

This invention provides a convenient and non-invasive chair-side method for producing a high resolution 4-dimensional model of jaw and tooth motion. The basic model includes the dentition and the surrounding soft tissue. The model is readily expanded by incorporating contiguous or related dynamic or static anatomic structures (obtained from a variety of imaging methods) so as to generate a more complete patient model. Modeling the natural dynamics of a patient's jaw motion and dentition provides the basis for a number of novel diagnostic and therapeutic procedures. The basic 3-dimensional registration method used to create the model in this invention may be applied to any dynamic 3-dimensional physical system.

The general method of this invention includes producing complete upper and lower digital models of the teeth and soft tissues of a patient, scanning the oral anatomy of the patient and registering the complete digital models with the scan. These components of the method are designated 10, 12 and 14, respectively, in the block flow diagram of FIG. 1A. More particularly, the foregoing method includes obtaining complete upper and lower 3-dimensional digital models of the teeth and mucosa, scanning the labial or buccal aspect of the teeth and soft tissues of a patient so as to capture the upper and lower arches and obtain a set of time-based 3-dimensional digital representations, and registering the complete upper and lower 3-dimensional models to the individual 3-dimensional scan images to produce a 4-dimensional model. These are designated 20, 22 and 24, respectively, in the block flow diagram of FIG. 1B.

For obtaining upper and lower digital models, several methods are known in the art for producing 3-dimensional digital models of the dentition, including laser scanning plaster models produced from oral impressions, direct intraoral scanning, scanning impressions and bites using x-ray or optical methods, and destructive methods to serially digitize oral impressions using contrasting boundaries. The primary requirement of any method used to model the dentition is sufficient accuracy and definition. An accuracy of less than 100 microns and approximately 100,000 points is required to sufficiently define a complete dental model. In this regard, the method used is not critical to the execution of this invention. A preferred method is laser scanning plaster models produced from standard oral impressions. The data files representing the model may be in a variety of formats. Ordered point or polygon data is generally sufficient for registering two 3-dimensional surface data sets to produce a 4-dimensional model.

With respect to scanning the oral anatomy of a patient, this aspect of the method involves obtaining a set of time-based 3-dimensional digital representations of the teeth during jaw motion by directly scanning oral structures of a patient. A typical scan image consists of a 3-dimensional labial view showing both the upper and lower teeth. Each scan provides the relative position of the two arches. The representations do not have to be anatomically complete, as they only need to provide sufficient data to enable accurate registration the complete upper and lower arches. With the lips partially retracted, a non-contacting digital imaging system is used to capture and record a series of 3-dimensional images that include the upper and lower teeth while the patient moves the mandible. Depending upon the imaging method and acquisition rate of the system, more than one set of images may be required to produce sufficiently smooth jaw motion data. Separate scans are typically performed to capture a specific motion such as lateral or protrusive excursions. More continuous-type motion can be produced by interpolating scans. An important feature of the scanning system is the ability to rapidly capture 3-dimensional images. The rate of imaging is preferably 2-50 Hz. or higher. Suitable methods include, but are not limited to laser-based triangulation cameras, optical pattern-based methods that analyze the reflection of a specially created or structured optical pattern, and ultrasound imaging.

The method is completed by registering the upper and lower digital models to the scan images. The 4-dimensional model is created by registering the surface contours of corresponding regions on the complete dental models and the individual upper and lower 3-dimensional serial scan images. Greater registration accuracy is achieved by using as much data as possible over as large a distance in three orthogonal directions. For this purpose, the surrounding soft tissue may be used to assist with registering. Areas used for registration must not have changed as a result of the relative motion in the system. A number of methods are known in the art for registering two 3-dimensional surfaces. Most differ in the type of data sampling and statistical methods used. The exact mathematical method used to register the data and create the 4-dimensional model is not critical to the execution of this invention.

The 4-dimensional model so produced by the method of this invention contains complete 3-dimensional details of the teeth as well as the true 3-dimensional opening and closing motion of the lower jaw. The 4-dimensional model can be displayed with respect to a fixed maxilla. Cephalometric data may be used to extract related dimensional data on skeletal structures to assist with modeling. Once the model is produced, a number of analytical software tools may be applied for diagnostic purposes. In addition, the model may be integrated with ultrasound, CT, or other imaging data to produce a more complete patient model.

The foregoing and additional advantages and characterizing features of the invention will become clearly apparent upon a reading of the ensuing detailed description together with the included drawing.

### BRIEF DESCRIPTION OF THE DRAWING FIGURES

FIGS. lA and IB are block flow diagrams illustrating the method of the invention;

FIG. 2 is a typical 3-dimensional labial scan suitable for registering upper and lower dental models; and

FIG. 3 shows a complete lower digital model registered to the scan of FIG. 2.

### DETAILED DESCRIPTION OF THE INVENTION

The method of the invention is for producing 4-dimensional models of dynamic physical systems based upon capturing discrete and relative 3-dimensional changes in the system's surface and registering the complete fixed aspects of the system to the time-based 3-dimensional images. A dynamic 3-dimensional (4-dimensional) model is thereby produced. The primary example used is the modeling of the human jaw and dentition system.

The first component of the method of the invention is obtaining upper and lower digital models of the teeth and soft tissues. This is designated 10 and 20 in FIGS. 1A and 1B, respectively. Several methods are known in the art for producing digital models of the dentition in a computer. The preferred methods are laser scanning plaster models produced from standard oral impressions and x-ray scanning impressions. High data density and accuracy is required. Accurate silicone impressions and low shrinkage dental stone should be used to produce models for laser scanning. Voids should be filled and imperfections resulting from the pour should be removed prior to scanning. Reduced laser power should be used to minimize scattering that can affect the effective line width of the laser. The complete models should have sufficient interproximal detail to allow accurate separation of the teeth into individual objects. This is important when analyzing tooth movement resulting from contact during mouth closing. Also, extraneous or spurious data should be eliminated from the individual scans as well as the complete dental models to optimize the efficiency of the registration process.

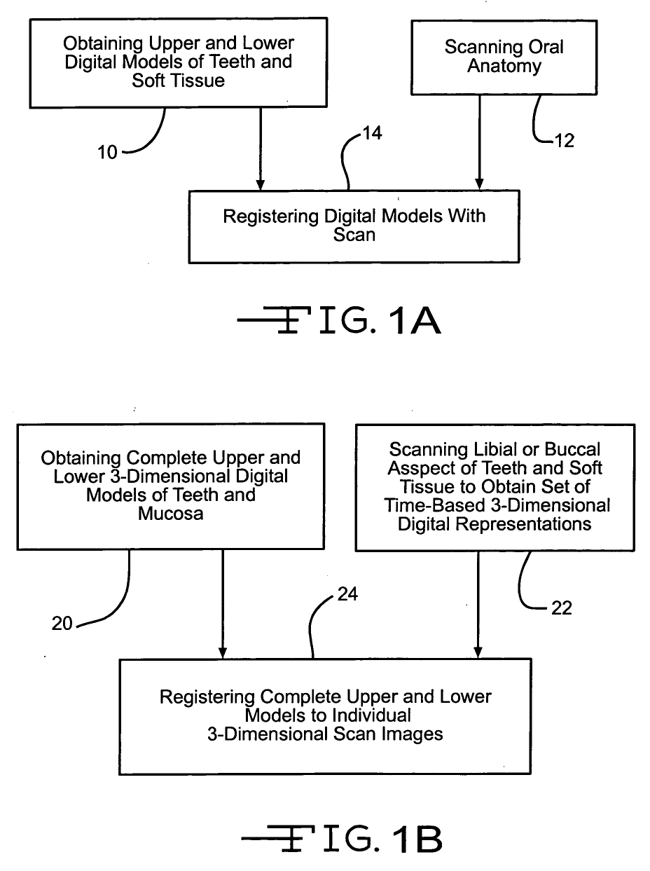

The next component of the method of the invention is obtaining time-based 3-dimensional digital representations of the teeth during jaw motion. This is designated 12 and 22 in FIGS. 1A and 1B, respectively. With the lips partially retracted, a digital imaging system is used to take a time-based series of 3-dimensional images of the labial or buccal surfaces of the upper and lower teeth and surrounding soft tissue. These images (scans) capture the relative 3-dimensional position of the upper and lower jaws at various times during jaw movement. FIG. 2 shows a typical 3-dimensional labial scan 30 suitable for registering upper and lower models. In particular, FIG. 2 is an example of a single 3-dimensional scan of the labial surface of the teeth used to relate the upper 32 and lower 34 dentition. Although the scan is incomplete, sufficient data exists to allow accurate registration of the upper and lower models.

A preferred scanning method is based upon analyzing the reflection of a structured optical pattern. These methods are generally faster than laser scanning methods. A scanning system can be based upon a standard white light grid flashed onto a reflecting surface. An electronic imaging device oriented along a second axis, to allow for triangulation, captures the reflected pattern from the object. Software compares the reflected pattern to a flat or other theoretical reflection to calculate the surface topology. A 3-dimensional point cloud is typically generated to provide the basis for recreating the scanned surface. Scanning is performed to capture jaw movement during specific excursions and in specific positions, such as:

a. During mouth opening and closing when the jaw is in centric position. These data can provide the 3-dimensional location of the theoretical hinge axis.

b. When the mandible is protruded to capture the shape of the eminence curve as the condyle slides over the meniscus.

c. Lateral excursions to evaluate range of motion or for balancing the occlusion.

d. During natural and random open/closing movements.

e. When the teeth are together in centric occlusion, in a bite position, or clenching.

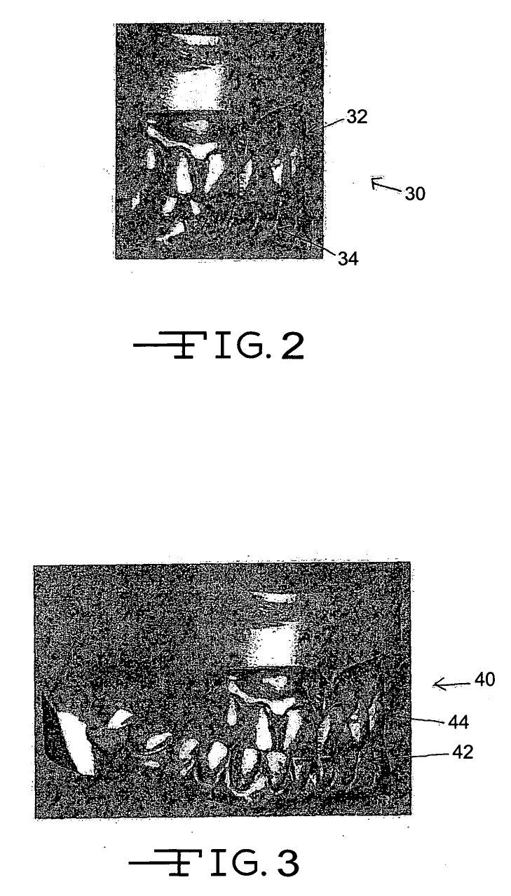

The final component of the method of the invention is registering the complete digital models with the serial scans. This is designated 14 and 24 in FIGS. 1A and 1B, respectively. Registration involves matching (comparing and orienting) corresponding surface regions of the serial images and the complete upper and lower dental models. A variety of 3-dimensional registration methods are known in the art. The basic registration method between two 3-dimensional models involves defining one object as fixed to which the second (floating) is matched. The individual scans are defined as the fixed objects, and the complete models are considered floating. FIG. 3 shows the result of registering the complete lower model to an individual scan. In particular, FIG. 3 shows a complete lower digital model 40 registered to the scan in FIG. 2. It can be seen that the lower dentition 42 is complete, and the upper 44 is still partial. Greater registration accuracy is achieved by comparing as much surface data as possible, and using data that spans a range in x, y, and z space. For this purpose, the surrounding soft tissue may be used to assist with registering. In practice, a balance is generally made between the calculation time and resultant accuracy. A number of established contour matching methods may be used to achieve equivalent results. The 4-dimensional model so produced generally moves the lower arch relative to a fixed upper arch.

In a preferred embodiment, fiduciary markers are placed on a patient's upper and lower arches prior to intraoral scanning to assist with registration. Prior to scanning the complete models, equivalent locations are indicated. The markers can assist software users with manual registration by identifying corresponding areas to be used for matching. Markers can also provide means for automatic registration. For example, a set of different colored or patterned markers may be placed on the teeth prior to scanning. The location of a specific marker may be determined by digitally analyzing the color and/or pattern of the 3-dimensional surface. The markers should preferably be located over the largest possible range of x, y, and z to ensure accurate registration. These same locations would be transferred to the complete model prior to scanning. The exact method used to register the scan images is not important to the principles of this invention since a large number of numerical and optical methods are known in the art for achieving substantially the same result.

If a single unidirectional jaw motion is scanned and used to produce a dynamic model, the time sequence of data files may be sufficient to order the files. If more than one scan is taken, scans must be placed in the proper time sequence, and mouth opening and closing segments must be differentiated. Data representing more than one opening (or closing) segment may be combined into a single ordered sequence of files.

An important geometric feature of scanning the oral cavity is that the system is inherently floating, in that it has no fixed reference coordinate system. Both the head and the jaw can move in space as well as with respect to each other. Generally, when scanning such systems, it is difficult to establish reliable reference coordinates since no element of the system is fixed. This invention overcomes this limitation by employing scans that provide incremental and accurate 3-dimensional data on the relative positions between the moving elements of the system (the mandible and the maxilla). Each scan includes a portion of the upper arch which allows the complete upper dentition to be registered. The location of the upper arch may then be continuously redefined (forced) to be located at a fixed position to provide a reference and enable the mandible to be moved relative to a fixed maxilla. This position may be simply at an average angle to the horizontal (approximately 15°), or obtained from a bite to other anatomic landmarks such a centric axis.

The properties of the 4-dimensional model produced by the method of this invention now will be described. The 4-dimensional model so produced consists of a set of digital files each representing a 3-dimensional position of the upper and lower arches. Once the model is produced, a variety of software tools may be applied for imaging or diagnostic purposes. A variety of coordinate systems is typically created to quantitate different elements of the model. For example, midline shifts may be analyzed using a coordinate system with a fixed vertical axis located along the midline of the upper jaw. Excursions of the lower arch relative to the reference provide midline shift data. These data may be viewed using a display or presented numerically as a graphical data.

In a preferred embodiment, the coordinate system used to construct the primary 4d model is based upon locating a centric axis from sequential patient scan data taken in centric relation. After a centric axis is located with respect to the lower arch, an intraoral scan taken at a bite position is used to locate the upper arch with respect to the lower. For display purposes, the lower occlusal plane at this bite position may be located at an average angle of approximately 15° to the horizontal.

In an alternative embodiment, an axis coordinate system is created in a computer by establishing an average centric axis by: 1) determining a lower occlusal plane from the complete lower model, 2) orienting the lower occlusal plane at an angle (approximately 15°) to a reference horizontal, 3) orienting the lower model with the jaw midline perpendicular to the axis, and 4) using an axis-incisal distance of approximately 100 rnm. Using an intraoral scan taken at a bite position, the location of the upper arch is determined and fixed. Following registration, the upper model is fixed in space to the same location, and the lower arch is allowed to move in three dimensions. In alternate embodiment, cranial cephalograms or CT images are used to identify a centric axis with respect to the upper or lower dentition.

The 4-dimensional model can be enhanced by abstracting and integrating-anatomical data from alternate methods. For example, the complete dental models can be anatomically related to cephalometric or CT data to provide additional anatomic data such as the outer surface of the mandible. A variety of display and imaging methods may used to work with the combined data. The user may control the movement of the lower jaw and view the simulation in three dimensions. The model may be sliced and viewed in a variety of planes. Measurements, trend lines, and angles may be determined between points in any view. Dimensional data may be taken and displayed as the mandible progresses through various excursions. The digital manipulation and subsequent mode of representation (video or otherwise) and display to a user of the data can be based upon a variety of techniques known in the art.

The 4-dimensional modeling produced by this invention provides the basis for several diagnostic techniques. The following examples illustrate specific applications.

### EXAMPLE 1

### Determining Centric Axis

Serial scan data is taken while a patient's jaw is maintained and moved in centric relation. The mandible is positioned and maintained in its terminal (uppermost) axis position and is slowly moved while the labial surfaces of the teeth are scanned. Scanning is performed prior to tooth contact. Keeping the upper arch fixed, the 3-dimensional location of a theoretical hinge axis is readily determined by mathematically fitting an arc to the data produced from this jaw movement. The arc of closure is analyzed to produce a theoretical hinge axis in three dimensions. Since all data is 3-dimensional, a 3-dimensional vertical line of closure may be determined. In practice, a set of 3-dimensional instantaneous center of rotation values (ICR) may be determined.

### EXAMPLE 2

### Determining Eminence Geometry

The method of this invention can be used to determine the 3-dimensional geometry of the temporomandibular joint eminence. Since the mandible provides a rigid connection between the lower dentition and the condyle, the 3-dimensional path of two remote points mathematically related to the lower arch is readily determined. These points lie on the center of rotation of each condyle and are separated by an intercondylar distance. These two condylar marker points are referenced to the lower arch. In a preferred embodiment, two such points on the centric axis are defined to reflect left and right side condylar motion.

The approximate location of the center of rotation of the condyle and intercondylar distance may be approximated from standard 2-dimensional lateral and frontal cephalometric images, or precisely determined using 3-dimensional CT methods. From a lateral view, a centric rotation point on the condyle may be identified and related to landmarks on the lower dentition. When using a 2-dimensional cephalograms, two orthogonal distance values are typically needed to locate an axis relative to points on the teeth. The distance between the condyles can be directly determined from a front cephalogram.

Alternatively, average clinical values may be used to define a hinge axis, and the location of two condylar markers. Average values are frequently used when mounting models to fabricate appliances in the laboratory when a case has not been mounted on an articulator by the doctor. Typical values used to locate a hinge axis are: 1) 15° lower occlusal plane; 2) 100 mm perpendicular distance from the axis to the tip of a lower central incisor; and 3) a 50 mm vertical height from the tip of a lower central to the hinge axis. Intercondylar distance is approximately 110 mm on a fully adjustable articulator.

Once left and right side centric marker points have been defined with respect to the lower teeth, then, scans taken during normal opening/closing, random movements, protrusive, and lateral excursions allows for the calculation of the locus of points assumed by the left and right centric marker points as the lower jaw moves with respect to a fixed upper. These data reflect the 3-dimensional geometry of the eminence. Individual left and right side geometry may thereby be determined and used for diagnostic and prosthesis fabrication purposes.

### EXAMPLE 3

### Custom Condylar Inserts

Knowledge of the individual condylar geometries may be used to fabricate patient-specific condylar inserts for dental articulators. The inserts are shaped to represent the actual geometry of the left and right side articular eminence of the temporal bone for a specific patient. Once the shape is determined, insert may be produced using a machine center. The custom inserts may also be produced by rapid prototyping methods. The inserts are placed in a dental articulator to assist with the laboratory fabrication of appliances and prostheses.

In this way, a relatively simple dental articulator fitted with custom condylar inserts can be used to duplicate the actual 3-dimensional excursions followed by path of the condyle from the fossa along the articular eminence. The insert would have means for attaching to an articulator. Current jaw tracking methods may also be worked-up as 3-dimensional models to produce custom condylar inserts.

### EXAMPLE 4

### Occlusal Equilibration

Occlusal equilibration (balancing) is reshaping the surfaces of teeth to alleviate stressful contacts that may interfere with normal jaw function. Successful equilibration results in a more equal distribution of contact forces and the elimination of interferences that can trigger muscle activity and contribute to joint problems. Current clinical and laboratory practice to identify tooth interferences uses thin colored films called articulating paper. This invention provides enhanced digital modeling of jaw and tooth motion that can assist with rebuilding the occlusion. A physical model of the equilibrated teeth can be produced using rapid prototyping methods to assist the doctor with performing the clinical procedure. Also, a computer-assisted display of the tooth locations requiring enamel removal may be provided chairside.

Since the 4-dimensional model of this invention contains a record of actual patient dynamics as well as knowledge of eminence geometry, the patient-specific rotations and excursions required to establish equilibration can be simulated in a computer. Software allows tooth surfaces to intersect, and intersecting volumes can be displayed and measured. Transparent shells can be used to visualize the intrusion of one surface into another. The excluded tooth volumes (tooth sections resulting from interferences) required to be eliminated to satisfy certain motions can be determined. This excluded volume is then selectively partitioned between the interfering teeth using well established clinical rules. The progression of tooth contact and sliding can also be studied. Reference may be made to P. Dawson. Evaluation, Diagnosis, and Treatment of Occlusal Problems. C. V. Mosby, St. Louis. 1989.

Using known 3-dimensional software tools, tooth surfaces requiring shaping may be selectively sculpted in a computer to relieve the undesired interferences arising from specific jaw motions. The process can be manual or software-driven. Virtual enamel is removed to develop a final occlusion that satisfies the required dental rules of equilibration. A physical model of the final balanced occlusion may be constructed using rapid prototyping methods. A model of the pre-balanced occlusion can also be produced indicating the locations to be removed. Colors or patterns can be used indicate the location of individual interferences. In this way, the tooth reshaping required for balancing a patient's occlusion can be determined and evaluated prior to clinically removing enamel. Clinically accepted rules and procedures for occlusal equilibration may be coded in software.

In general, occlusal equilibration requires tooth interference data to be produced for three basic jaw motions 1) Centric rotation; 2) Lateral excursions; and 3) Protrusive excursions. Different colors or patterns may be used to differentiate centric, lateral, and protrusive interferences. Tooth areas with more than one type of interference may be displayed with a combination effect. Using the 4-dimensional dynamic model provided by this invention, the location and sequence of tooth contacts may be determined and displayed.

### EXAMPLE 5

### Determining 3-dimensional Tooth Movement Upon Closure

When the mouth is closed, a series of tooth contacts and sliding motions typically occurs that leads to full occlusion. Tooth moment that occurs upon closing the mouth may also be determined by the methods of this invention. This application requires clinically scanning the teeth to be analyzed for movement. Scans are obtained beginning from an open bite position and proceeding to full closure. A series of scans is thereby created that contains the relative position of the upper and lower arches as well as incremental 3-dimensional tooth movement information.

To visualize and characterize tooth movement, a scan taken in an open bite position is used as a reference. Alternatively, a model produced from a full mouth impression that minimizes tooth movement by using very gentle technique, may be used as a reference. Alternatively, individual scans taken with an open bite may be combined to form a complete model. Such a complete model may be used as a reference for analyzing subsequent tooth movement.

The individual scans taken during tooth contact and mouth closure are compared with a reference open bite scan or full model scan. A 3-dimensional color coded map may be produced illustrating the dimensional differences between the two objects. This map represents the isolated tooth movement. By this method, a time-based series of color images is generated showing the progression of tooth movement.

### EXAMPLE 6

### Obtaining a Bite Registration

Current clinical practice involves using wax to take, or record, a bite registration. Wax can break and distort. In practice, there is also frequently a slight ‘rock’ to the models when placed in the bite position. The limitations of current art are well known, and have become standard practice. A single 3-dimensional scan, according to the present invention, may be used to non-invasively and digitally record a bite registration position on a patient. No wax or any material is used, and the digital bite record may be integrated into current orthodontic diagnostic software. This method provides a more accurate recording since no materials must be placed in the patient's mouth. A digital bite registration may be used to articulate models in a computer as part of a digital manufacturing process.

### EXAMPLE 7

### Integration with Data from other Modes of Scanning

By combining the basic 4-dimensional model with secondary 2-dimensional or preferably 3-dimensional anatomic data on adjacent structures, a more complete patient model may be produced. The secondary anatomic data added to the basic model may be static (not time-based) or dynamic. Examples of adjacent or secondary anatomic data include, but is not limited to: 1) craniofacial skeletal data obtained using x-ray based techniques; 2) TMJ data obtained using MRI, PET, or x-ray techniques; and 3) facial soft tissue data obtained from 3d optical scanning or 2d photographs.

It is therefore apparent that the invention accomplishes its intended objectives. While embodiments of the invention have been described in detail, that has been done for the purpose of illustration, not limitation.

1. A method for modeling jaw and tooth motion of a patient comprising:
a) obtaining upper and lower digital models of the teeth and soft tissues of a patient;
b) obtaining a scan(s) of the oral anatomy of the patient; and
c) registering the digital models with the scan(s) to provide a 4-dimensional model of jaw and tooth motion of the patient.

2. A method according to claim 1, wherein obtaining upper and lower digital models comprises obtaining complete upper and lower 3-dimensional digital models of the teeth and mucosa.

3. A method according to claim 2, wherein obtaining 3-dimensional digital models of the teeth and mucosa comprises scanning models produced from oral impressions.

4. A method according to claim 1, wherein obtaining a scan of the oral anatomy comprises obtaining time-based 3-dimensional representations of the teeth during jaw motion.

5. A method according to claim 4, wherein obtaining a scan of the oral anatomy comprises scanning the labial or buccal aspect of the teeth and soft tissue of the patient so as to obtain a scan image comprising a 3-dimensional labial or buccal view showing both upper and lower teeth.

6. A method according to claim 1, wherein registering the digital models with the scan(s) comprises registering complete upper and lower 3-dimensional models to individual 3-dimensional scan images obtained from scanning the oral anatomy to provide the 4-dimensional model.

7. A method according to claim 6, wherein registering the digital models with the scan comprises registering surface contours of corresponding regions on the 3-dimensional models with the individual 3-dimensional scan images of upper and lower arches.

8. A method for producing a 4-dimensional model of a dynamic physical system comprising:
a) digitally capturing discrete and relative 3-dimensional changes in a surface of the system; and
b) registering complete fixed aspects of the system to time-based 3-dimensional images to produce the 4-dimensional model.

9. A method according to claim 8, wherein the dynamic physical system is a human jaw and dentition system.

10. A method for modeling jaw and tooth motion of a patient comprising:
a) producing a 4-dimensional model comprising a set of digital files each representing a 3-dimensional position of the upper and lower dental arches of the patient; and
b) analyzing different elements of the model for imaging and diagnostic purposes.

11. A method according to claim 10, wherein said analyzing different elements of the model includes creating a coordinate system.

12. A method according to claim 11, wherein the coordinate system is based upon a centric axis and a jaw midline.

13. A method according to claim 12, wherein a standard centric axis coordinate system and a bite position is defined by:
a) determining a lower occlusal plane using the complete lower model;
b) setting the lower occlusal plane at a predetermined angle to a reference horizontal;
c) orienting the model of the lower dental arch with the jaw midline perpendicular to the centric axis;
d) using a predetermined axis-incisal distance to complete the location of the lower model and the centric axis; and
e) positioning the upper model with respect to the lower using a scan taken at a closed or bite position.

14. A method according to claim 10, wherein a centric axis is identified with respect to upper or lower dentition of the patient.

15. A method according to claim 10, wherein analyzing different elements of the model includes controlling movement of the model of the lower dental arch to view simulation in three dimensions.

16. A method according to claim 10, wherein analyzing different elements of the model includes slicing and viewing the model in a variety of planes.

17. A method according to claim 10, wherein analyzing different elements of the model includes determining measurements, trend lines and angles between points in a selected view.

18. A method according to claim 10, wherein analyzing different elements of the model includes taking and displaying dimensional data during progression of the mandible through an excursion.

19. A method for modeling jaw and tooth motion of a patient comprising:
a) scanning the surface of the patient's teeth to obtain time-based 3-dimensional representations of the teeth during jaw motion; and
b) utilizing the results of the scanning to provide diagnostic or treatment-based geometric information relating to the tooth and jaw motion.

20. A method according to claim 19, wherein the labial surface of the patient's teeth is scanned while the patient's jaw is moved in centric relation and wherein utilizing the results of the scanning comprises:
a) determining the 3-dimensional location of a hinge axis by mathematically fitting an arc to data produced from the scanning; and
b) determining a centric axis in the form of a 3-dimensional line.

21. A method according to claim 19, wherein utilizing the results of the scan comprises:
determining mathematically from the scan the 3-dimensional path of two condylar marker points referenced to the lower dental arch of the patient located on or near the centric axis and separated by an intercondylar distance in; defining the points in a coordinate system including the patient's teeth; performing a series of scans of the surface of the patient's teeth during a variety of opening and closing and other excursions of the patient's jaw; and
calculating the locus of the points followed by the marker points as the patient's lower jaw moves to determine the right and left side 3-dimensional geometry of the temporomandibular joint eminence.

22. A method according to claim 19 further comprising:
a) utilizing the 3-dimensional geometry obtained from scanning the surface of a patient's teeth to obtain the geometry of the left and right side articular eminence of the temporal bone for a patient; and
b) fabricating for that patient customized left and right side condylar inserts for a dental articulator.

23. A method according to claim 19, wherein said diagnostic and treatment-based information includes simulating the patient-specific rotations and excursions required to establish occlusal equilibration and wherein said method further comprises simulating via software the patient tooth surfaces requiring shaping to relieve undesired interferences arising from specific jaw motions.

24. A method according to claim 19, wherein the scanning is performed beginning from an open bite position and proceeding to a fully closed or clenched position to provide a series of scans and wherein the series of scans is compared to a reference open bite scan to determine 3-dimensional tooth movement upon closure.

25. A method according to claim 19, wherein a single 3-dimensional scan is utilized to provide a digitally recorded bite registration for the patient.

26. A method according to claim 10, wherein the 4-dimensional model is combined with secondary anatomic data on adjacent patient structures to provide an enhanced patient model.

27. A method according to claim 26, wherein the secondary anatomic data is obtained from two or 3-dimensional x-ray methods.

28. A method according to claim 26, wherein the secondary anatomic data is dynamic or time-based.
